(19) United States
(12) Patent Application Publication
(10) Pub. No.: US 2003/0057762 A1
(43) Pub. Date: Mar. 27, 2003

(54) Seat belt with printed face and printing method thereof

(76) Inventor: Sung-Soo Kim, Seoul (KR)

Correspondence Address: FOLEY AND LARDNER, SUITE 500, 3000 K STREET NW, WASHINGTON, DC, 20007, US

(21) Appl. No.: 09/783,392

(22) Filed: Feb. 15, 2001

(30) Foreign Application Priority Data
Feb. 18, 2000 (KR) 2000-007791
Feb. 18, 2000 (KR) 2000-004511

(51) Int. Cl. B60R 22/12

(52) U.S. Cl. 297/468

(57) ABSTRACT

A seat belt with a printed face is disclosed. In addition to its general function to save a life in a possible incident of a vehicle, when a user puts on the seat belt, since the printed face, on which a character, a mark or a pattern is solidly displayed, stands out on the seat belt, elegance and reliability of the product can be conspicuously elevated. Also, when the user puts on the seat belt, the grasp portion by the user's hands are prevented from slipping, so that the user can put on and take off the seat belt easily. Moreover, the sensitivity in putting on the seat belt can be promoted, a luminous layer may be coated on the seat belt, according to the user's taste in using the seat belt.

### BACKGROUND OF THE INVENTION

1. Field of the Invention

The present invention relates to a seat belt with a printed face on which a character, a mark or a pattern is solidly formed and its printing method, and more particularly, to a seat belt with a printed face which is capable of confirming whether a user puts on a seat belt properly to avoid any unexpected incident by forming a seat belt manufacturer's brand name or various printed decorations at the outer side of the seat belt, capable of obtaining a decorative effect by forming a sensitively recognizable expression in addition to the inherent function of simple use of the existing safety belt, and capable of allowing users to stably put on the seat belt by preventing-a grasp portion by a user's hand from slipping thanks to the solidly formed printed face.

2. Description of the Background Art

Generally, since a seat belt is considered to have a direct relation with a possible incident, a tenacious material, i.e., a synthetic fiber such as polyester, etc, is used for the seat belt by weaving in a band form with a certain thickness.

Polyester used for a seat belt is a polycondensation body, having a intense tenacity. Since its textile face has a smooth touch, when the user puts on or takes off the seat belt made of polyester, a slipping abrasion between the seat belt and the body of the user is minimized. In addition, advantageously, it can alleviate or absorb an impact possibly applied to the body of the user in a collision incident.

With these merits, the seat belt is primarily adopted in terms of its function to save a life in a possible vehicle incident.

In addition to this, current tendency shows that two-point and three-point fixture type engaging structures. have been proposed to complement the simple function of the seat belt, and the tenacity of the seat belt itself is being more intensified.

### SUMMARY OF THE INVENTION

Therefore, an object of the present invention is to provide a seat belt that is capable of conspicuously obtaining an elegant appearance of a product and a reliability by forming a printed face at the outer side of a seat belt on which a character, a mark or a pattern is solidly displayed in addition to its general simple function, capable of facilitating putting on and taking off the seat belt by preventing user's hands from slipping when he or she puts on the seat belt by forming a printed face on the seat belt as well as maintaining the general function of the seat belt, and capable of maintaining a durability of the printed face without a phenomenon that permeability and adhesive strength of a printed ink of the seat belt is weak and detached therefrom, and its printing method.

Another object of the present invention is to provide a polyester seat belt with printed surface on which a character, a mark or a pattern is solidly displayed, the printed surface being maintained durably without being detached, and its printing method.

Yet another object of the present invention is to provide a seat belt with a printed face of which a molding-processed portion and a portion which does not undergo molding are conspicuous in case that a desired printed face is molded on a seat belt, and its printing method.

In the present invention, a printed face is formed at one side of a band-type seat belt woven with polyester, on which a character, a mark and a pattern are conspicuously displayed.

In the present invention, the printed face is made of a silicon rubber material or a sol ink (plastic sol or span sol). The seat belt made of polyester is conveyed along with a conveyer. One face of the seat belt is multicolor-printed and dried by a print unit and a dry unit which are installed at equal intervals at the convey path of the conveyer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view showing an example that a seat belt is mounted at a sheet of a general vehicle;

FIG. 2 is a diagram showing a process of a printing method of a seat belt in accordance with one embodiment of the present invention;

FIG. 3 is a partial cut plan view of a printed face with a mark of a seat belt in accordance with the present invention;

FIG. 4 is an enlarged sectional view of the seat belt in accordance with the present invention;

FIG. 5 is a partial cut plan view of a printed face with a different mark of a seat belt in accordance with the present invention;

FIG. 6 is a partial cut plan view of a printed face with a different mark of a seat belt in accordance with the present invention; and

FIG. 7 is a diagram showing a process of a printing method of a seat belt in accordance with another embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

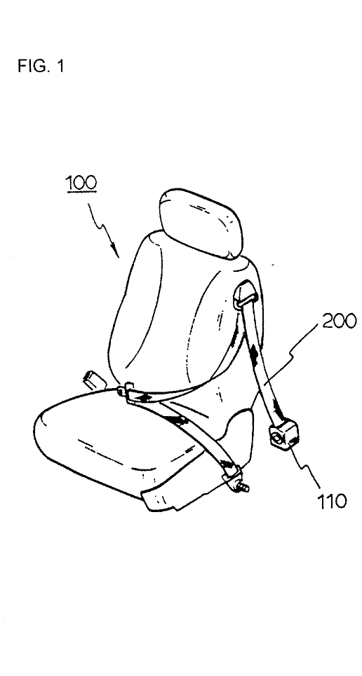

FIG. 1 is a perspective view showing an example that a seat belt is mounted at a seat of a general vehicle, in which the seat belt 200 is coupled with a binding unit 110.

The seat belt 200 is called a three-point fixture type safety belt which is widely used. The belt is mass-produced by a general weaving process and made of a polyester synthetic fiber which has a property of strong tenacity.

A print member constructing the printed face 210 on the seat belt includes oil ink (PVC ink, nylon ink or UV ink), urethane ink, radio frequency and razor printing. In addition, pattern display methods includes a decalcomania method, a display method on a raw material cloth for a seat belt by jacquard texture, and a computer embroidering method.

Especially, the print member for the seat belt of the present invention includes a liquid phase silicon rubber, a plastic sol or a span sol, a sol ink.

Besides, a silk printing and decalcomania may be adopted as a print member in the present invention, and as a print member for the seat belt, a radio frequency, a razor printing and jacquard method are employed.

The print member may be used by mixing a pigment according to colors desired to be adopted.

The silicon of the present invention, used as ink, is made by mixing a pigment, a viscosity intensifier and a hardener with a liquid-phase silicon resin, for which an additive of silone (epoxy amine) is additionally included as an addition promotor to improve the adhesive strength.

The silicon composition comprises 8˜15 wt % of silicon oil, 2˜10 wt % of epoxy silane, 0.5˜1.0 wt % of amino silane, 0.1˜0.4 wt % of platinum catalyst, 0.3˜1.0 wt % of pigment, 1˜8 wt % of calcium carbonate (CaCO₃), 2˜10 wt % of silica 200 mesh or 300 mesh, for a silicon liquid phase rubber 100 wt %.

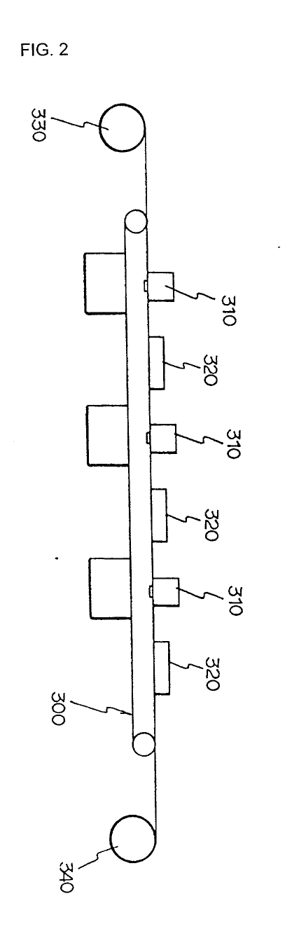

The printing method of the present invention will now be explained with reference to FIG. 2.

The seat belt 200 made of polyester is conveyed along with the conveyer 300. While being conveyed, one face of the seat belt is subject to multicolor-printing and drying by the print units 310 and the dry units 320 respectively installed at equal intervals on the convey path of the conveyer 300.

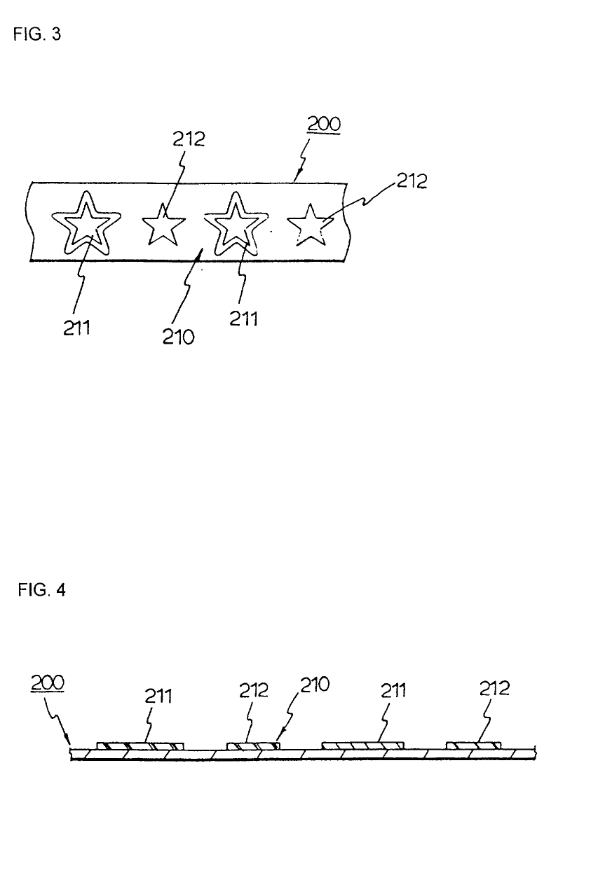

The conveyer 300 adopts an endless tracking system so that the seat belt 200 desired to be printed is supplied by a roll 330 at one side of the conveyer 300 (the left side of the illustration of FIG. 3), and as the seat belt is completed printed and dried, it is wound up on a roll 340 at the other side (the right side of the illustration of FIG. 3) of the conveyer 300.

FIG. 3 shows a case that three print units 310 and three dry units 320 are installed at equal intervals on the conveyer 300, which, however, can be increased or reduced in number as required.

The print unit 310 on the conveyer 300 is automatically controlled by an electronic controller. When the seat belt 200 is moved along with the conveyer 300, a first color and a first pattern of a predetermined character or figure are screen-printed on a face of the seat belt by the first print unit 310, and subsequently, the first color and the first pattern-printed seat belt 200 is dried by the first dry unit 320.

And then, as the seat belt 200 enters the second print unit 310 installed spaced apart from the second dry unit 320 along with the conveyer 300, a first color and a first pattern of a predetermined character or figure different from that of the first print unit 310 are screen-printed on the face of the seat belt 200, and as the seat belt 200 enters the second dry unit 320, the printed face on the seat belt is dried.

In the same manner, when the seat belt 200 enters the third print unit 310 disposed spaced apart from the second dry unit 320 along with the conveyer 300, a first color and a first pattern of a predetermined character or figure different from those of the first print unit 310 and of the second print unit 310 is screen-printed on the face of the seat belt 200, and as the seat belt enters the third dry unit 320, the printed face on the seat belt 200 is dried.

As the seat belt completely passes the three print units 310 and dry units 320, the printed face 210 of the three colors and three patterns of different characters or figures are formed on the seat belt 200.

The printed face 210 of the seat belt 200 may pass the print unit 310 selectively according to a color or a pattern of a certain character or figure, or the print unit and the dry unit can be installed more or less in number.

The silicon used as ink in the present invention is made by mixing a pigment, a viscosity intensifier and a hardener with the liquid phase silicon resin, to which an additive of a silone (epoxy amine) is additionally contained as an addition promoter to thereby improve its adhesive strength.

As the seat belt passes through the printing process and the drying process, a printed face is formed at the upper surface (one face) of the seat belt 200. In this respect, with reference to FIG. 3, when the seat belt 200 passes the first print unit 310, the double pattern of star 211 is printed thereon. When the seat belt 200 passes the next print unit 310, the smaller pattern of star 212 is printed thereon. At this time, the double pattern of star 211 and the smaller pattern of star 212 may have different colors according to the pigment of the print member.

As shown in FIG. 4, the printed face 210 of the seat belt 200 is embossed on the upper surface of the seat belt 200 and adhesively molded thereon.

Thus, since the printed face 210 is embossed on the upper surface of the seat belt 200, when the user puts on the seat belt, the grasp portion by user's hand is prevented from slipping, so that he or she can easily put it on or take it off.

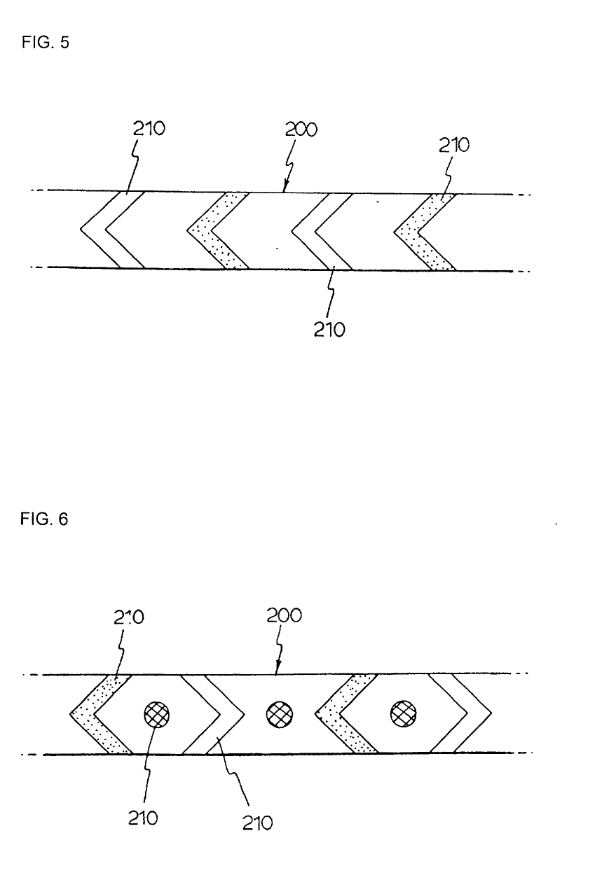

FIG. 5 illustrates an example that a printed face of a multicolor and a first pattern of a predetermined figure is formed by multicolor on the seat belt, and FIG. 6 illustrates an example that a printed face of multicolor and multiple patterns of different characters or different figures is formed on the seat belt.

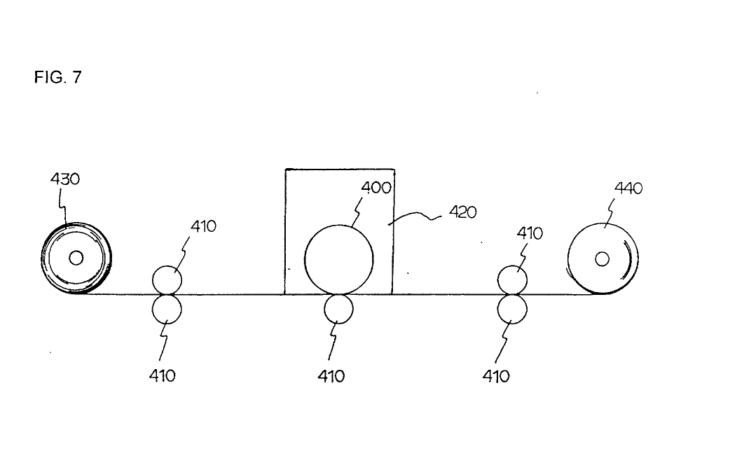

FIG. 7 is a diagram showing a process of a printing method of a seat belt in accordance with another embodiment of the present invention.

As shown in the drawing, the seat belt 200 is wound up on the roll 430 and guided by guide rolls 410 to pass a liquid phase print member supply roll 400 and a dry unit 420, and then finally wound up on a roll 440.

The liquid phase print member roll 400 is supplied with a liquid phase print member from a supplier (not shown). Since the circumferential surface thereof is formed as a masking face with a certain character or a figure, so that the print member produces a printed face on the seat belt 200 as state above.

The liquid phase print member roll 400 is variably and suitably modified in the design according to a character and a figure, and the method for supplying the print member can be modified suitably depending on a physical property of a print member.

In addition, as aforementioned, the liquid phase silicon rubber is adoptable according to the property of ink, or a plastic sol, a span sol, a silk printing and decalcomania can be employed.

As so far described, the seat belt of the present invention has many advantages. For example, first, in addition to its general function to save a life in a possible incident of a vehicle, when a user puts on the seat belt, since the printed face, on which a character, a mark or a pattern is solidly displayed, stands out on the seat belt, elegance and reliability of the product can be conspicuously elevated.

Secondly, in addition to the intrinsic function of the seat belt, when the user puts on the seat belt, the grasp portion by the user's hands are prevented from slipping, so that the user can put on and take off the seat belt easily.

In addition, the sensitivity in putting on the seat belt can be promoted, a luminous layer may be coated on the seat belt, according to the user's taste in using the seat belt.

Moreover, at the side of automobile companies, car advertisement can be made with sensitivity, drawing users' attention. Therefore, advertisement effect can be maximized.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A seat belt with a printed face for a vehicle, in which a printed face of a character, a mark and a pattern is formed at one face of a seat belt formed in a band shape woven with polyester.

2. The seat belt of claim 1, wherein the printed face is made of silicon rubber

3. The seat belt of claim 1, wherein the printed face is made of sol ink.

4. The seat belt of claim 1 or 3, wherein the printed face is formed with a multicolor printed pattern.

5. The seat belt of claim 2, wherein the silicon composition comprises 8˜15 wt % of silicon oil, 2˜10 wt % of epoxy silane, 0.5˜1.0 wt % of amino silane, 0.1˜0.4 wt % of platinum catalyst, 0.3˜1.0 wt % of pigment, 1˜8 wt % of calcium carbonate (CaCO₃), 2˜10 wt % of silica 200 mesh or 300 mesh, for a silicon liquid phase rubber 100 wt %.

6. The seat belt of claim 1, wherein the printed face is formed by silk printing.

7. The seat belt of claim 1, wherein the printed face is formed by a decalcomania.

8. A method for printing a seat belt with a printed face for a vehicle, in which the a seat belt made of polyester is conveyed along with a conveyer, and while being conveyed, one face of the seat belt is subject to multicolor-printing and drying by means of print units and dry units respectively installed at equal intervals on the convey path of the conveyer.
